(19) United States
(12) Patent Application Publication
(10) Pub. No.: US 2025/0390383 A1
(43) Pub. Date: Dec. 25, 2025

(54) APPARATUSES, SYSTEMS, AND METHODS FOR JENKINSON ADJUSTED MAGNITUDE ERROR CORRECTION

(71) Applicant: Micron Technology, Inc., Boise, ID (US)

(72) Inventors: Matthew D. Jenkinson, Boise, ID (US); Wesley W. Borie, Boise, ID (US); John Vachek, Boise, ID (US)

(73) Assignee: Micron Technology, Inc., Boise, ID (US)

(21) Appl. No.: 19/227,158

(22) Filed: Jun. 3, 2025

Related U.S. Application Data
(60) Provisional application No. 63/662,271, filed on Jun. 20, 2024.

(51) Int. Cl. G06F 11/10

(52) U.S. Cl. CPC G06F 11/1044

(57) ABSTRACT

A memory device includes a Jenkinson adjusted magnitude (JAM) error correction circuit. The JAM error correction circuit converts data into symbols in a finite field, and then generate magnitude and error correction bits from those symbols. During a read operation, the JAM error correction circuit generates an error magnitude based, in part, on the magnitude error correction bits and generates an error position based, in part, on the position error correction bits. The JAM error correction corrects the symbol at the location specified by the error position by an amount specified by the error magnitude. The use of the finite field may help simplify the logic operations compared to other multi-bit error correction schemes.

### CROSS REFERENCE TO RELATED APPLICATION(S)

This application claims the benefit under 35 U.S.C. § 119 of the earlier filing date of U.S. Provisional Application Ser. No. 63/662,271 filed Jun. 20, 2024 the entire contents of which is hereby incorporated by reference in its entirety for any purpose.

### BACKGROUND

Information may be stored on memory cells of a memory device. The memory cells may be organized at the intersection of word lines (rows) and bit lines (columns). During access operations, the memory accesses information in the memory cells for example to write new information to those memory cells as part of a write operation or to read information from the memory cells as part of a read operation.

Memory devices may use error correction in order to protect the integrity of the stored information. For example, when data is written to the memory device, a set of error correction bits may be generated based on the write data and the data and error correction bits written to the memory cells. During an example read operation the data and error correction may be read out and the data is corrected based on the error correction bits before being provided off the device. Different error correction schemes may have different error correction capabilities, but schemes which correct an increased number of errors may use relatively complicated math which requires an impractical number of logic gates to implement. There may be a need for error correction with an increased error correction capability which does not require difficult to implement math.

### BRIEF DESCRIPTION OF THE DRAWINGS

FIG. 1 is a block diagram of a memory system according to some embodiments of the present disclosure.

FIG. 2 is a block diagram of a JAM error correction circuit according to some embodiments of the present disclosure.

FIG. 3 is a block diagram of logic circuits which may be used to implement one or more of the components of an error correction circuit according to some embodiments of the present disclosure.

FIG. 4 is a table showing an example finite field according to some example embodiments of the present disclosure.

FIG. 5 are tables of an example set of data and error correction bits during write and read operations according to some examples of the present disclosure.

FIG. 6 is a flow chart of a method of performing a write operation using JAM error correction according to some example embodiments of the present disclosure.

FIG. 7 is a flow chart of a method of performing a read operation using JAM error correction according to some example embodiments of the present disclosure.

FIG. 8 is a block diagram of a bounded-fault compliant JAM error correction circuit according to some embodiments of the present disclosure.

FIG. 9 is a table of an example set of data and error correction bits according to some examples of the present disclosure.

FIG. 10 is a flow chart of a method of performing a read operation using BF-JAM error correction according to some example embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Information in a memory array may be accessed by one or more access operations, such as read or write operations. During an example access operation a word line may be activated (or opened) based on a row address and then selected memory cells along that active word line may have their information read or written to based on which bit lines are accessed, which may be based on a column address. When the access operation is over, the word line may be pre-charged to inactivate (or close) the word line.

The memory may include an error correction circuit. During a write operation, the error correction circuit generates error correction bits, such as parity bits, based on the write data. During a read operation, the error correction circuit receives read data and the error correction bits. The error correction circuit generates error correction bits from the read data and compares them to the originally encoded error correction bits. If there is a difference, it may indicate an error and the error correction circuit may correct the read data, for example, by flipping the state of bits determined to be in error.

Different error correction schemes may provide different levels of error correction. For example, Hamming code based error correction may be relatively easy to implement, but may generally not be capable of correcting more than a single bit worth of error. Reed-Solomon based error correction may be capable of correcting more bits of error, however, Reed-Soloman may involve a complicated implementation with a relatively large number of logic gates required for computation, which in turn may make it relatively slow. There may be a need for an error correction scheme with increased error correction capability, but with a relatively simple implementation.

The present disclosure is drawn to apparatuses, systems, and methods for Jenkinson adjusted magnitude (JAM) error correction. A memory device includes a JAM error correction circuit which implements a JAM error correction scheme. The JAM error correction scheme uses a finite field to translate the write data into symbols. For example, every N bits of the data may form a symbol, and the value of those N bits determines a value of the symbol. Based on the symbols, position error correction bits and magnitude error correction bits are generated. During a read operation, the data is read out along with the position and magnitude bits. The read data is decoded into symbols and position and magnitude bits are determined from the read data. If those do not match the position and magnitude bits which were read from the array, it indicates an error. If there is an error, the JAM error correction circuit generates an error position and an error magnitude. The error position determines which symbol of the data should be changed and the magnitude determines how it should be changed. Up to all of the N bits within one symbol may be corrected. Because the position, magnitude, error position, and error magnitude bits are all calculated based on the finite field, the JAM error correction circuit may implement the operations of JAM error correction using relatively simple logic, such as using bit-wise XOR gates.

In some embodiments, the JAM error correction scheme may be used for bounded fault error correction. The memory device may be coupled to a controller, and the controller may also be capable of performing error correction. The controller may be capable of correcting all of the errors within certain portions of the data, for example in the data along a single data terminal. In a bounded fault JAM scheme, even if the JAM circuit is not capable of correcting the errors, for example because they extend across multiple symbols, it will not alias the error across multiple fault regions. This allows the data to remain compliant with the controller's error correction scheme.

The present disclosure is generally described with respect to an example application where JAM error correction is used as part of a memory device. However, JAM error correction may be used in any application where error correction is desired. For example, the JAM error correction described herein may be used for wireless communications such as Wi-Fi or 5G communications. Instead of using written and read data as described, the JAM error correction may be performed in an analogous fashion on received and sent data as part of wireless communications.

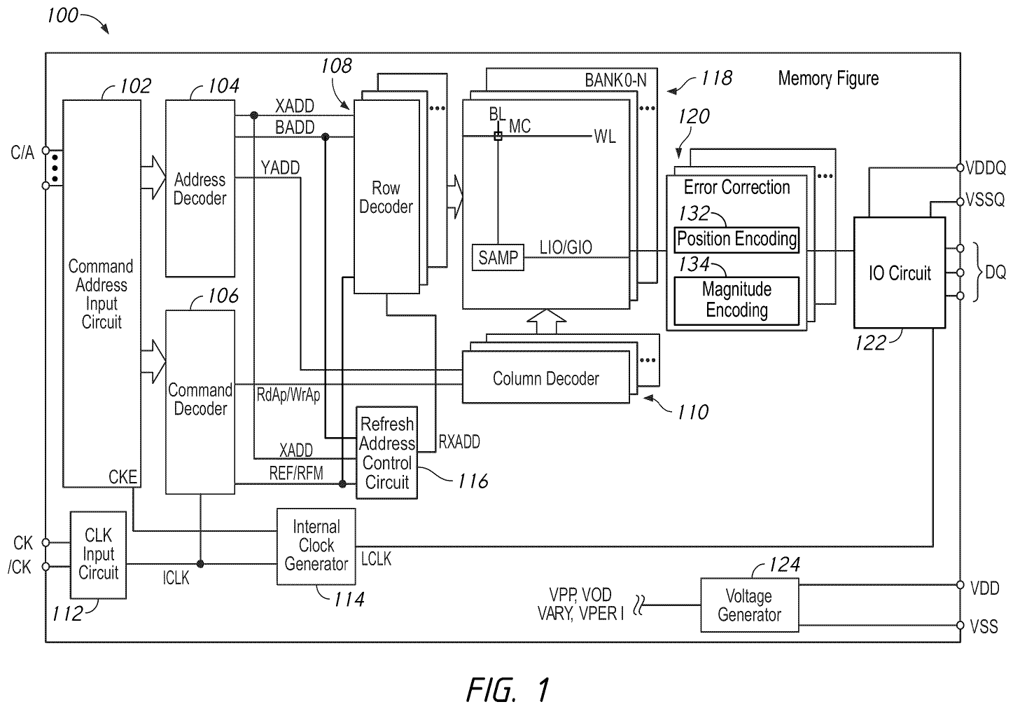

FIG. 1 is a block diagram of a semiconductor device according to at least one embodiment of the disclosure. The semiconductor device 100 may be a semiconductor memory device, such as a DRAM device integrated on a single semiconductor chip. The device 100 may be operated by a controller. The memory receives various commands, data, signals, and voltages (e.g., from the controller).

The semiconductor device 100 includes a memory array 118. The memory array 118 is shown as including a plurality of memory banks. In the embodiment of FIG. 1, the memory array 118 is shown as including N+1 memory banks BANK0-BANKN. For example, there may be four, eight, or sixteen banks. More or fewer banks may be used in other example embodiments. Each memory bank includes a plurality of word lines WL (rows), a plurality of bit lines BL (columns), and a plurality of memory cells MC arranged at intersections of the plurality of word lines WL and the plurality of bit lines BL. Each memory cell stores information. For example, the memory cell may be a capacitive element which stores a bit of information as an amount of charge on the capacitive element.

The selection of the word line WL is performed by a row decoder 108 and the selection of the bit lines BL is performed by a column decoder 110. In the embodiment of FIG. 1, the row decoder 108 includes a respective row decoder for each memory bank and the column decoder 110 includes a respective column decoder for each memory bank. The bit lines BL are coupled to a respective sense amplifier (SAMP). During an access operation, the row decoder 108 activates the word line specified by a row address XADD. The memory cells MC along the active word line are coupled to the intersecting bit lines BL. The sense amplifiers SAMP amplifies the signal along the bit line, either to the memory cell in a write operation or from the memory cell in a read operation. The column decoder 110 selects one or more bit lines to couple through local and global input output lines (LIO/GIO) outside the array 118.

The semiconductor device 100 may employ a plurality of external terminals. The external terminals include command and address (C/A) terminals along a command and address bus to receive commands and addresses. Other external terminals include clock terminals to receive clocks CK and/CK along a clock bus, data terminals DQ to send and receive data along a data bus, and power supply terminals to receive power supply potentials such as VDD, VSS, VDDQ, and VSSQ. The memory device 100 also includes data strobe (DQS) terminals which are used to receive a DQS signal. The DQS signal is used by an input/output (IO) circuit 122 to clock data as it is being sent or received along the DQ terminals.

The clock terminals are supplied with external clocks CK and/CK that are provided to an input circuit 112. The external clocks may be complementary. The input circuit 112 generates an internal clock ICLK based on the CK and/CK clocks. The ICLK clock is provided to the command decoder 110 and address decoder 108 and to an internal clock generator 114. The internal clock generator 114 provides various internal clocks LCLK based on the ICLK clock. The LCLK clocks may be used for timing operation of various internal circuits. For example, the clock signal LCLK may be a divided clock signal which is half the frequency of the external clocks CK and/CK.

The C/A terminals may be supplied with memory addresses. The memory addresses supplied to the C/A terminals are transferred, via a command/address input circuit 102, to an address decoder 104. The address decoder 104 receives the address and supplies a decoded row address XADD to the row decoder 108 and supplies a decoded column address YADD to the column decoder 110. The address decoder 104 may also supply a decoded bank address BADD, which may indicate the bank of the memory array 118 containing the decoded row address XADD and column address YADD. The C/A terminals may be supplied with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

The commands may be provided as internal command signals to a command decoder 106 via the command/address input circuit 102. The command decoder 106 includes circuits to decode the internal command signals to generate various internal signals and commands for performing operations. For example, the command decoder 106 may provide a read signal or a write signal to the column decoder 110 responsive to a read or write command respectively. The read command may cause the data on the bit line(s) selected by the column decoder 110 to be read out along the LIO/GIO lines. The write command may cause data to be written along the LIO/GIO lines to the selected bit line(s) and through them to the memory cells.

The memory device 100 includes on-device error correction. The memory device 100 includes an error correction circuit 120. The error correction circuit 120 is a JAM error correction circuit which uses JAM to perform error correction. During write operations, the JAM error correction circuit 120 generates a set of error correction bits based on the write data. The data and its associated error correction bits are written to the array. During read operations, the JAM error correction circuit 120 receives data and its associated error correction bits from the array, and uses the data and error correction bits to determine if the data contains an error. If an error is detected, the JAM error correction circuit 120 corrects the error in the data.

The error correction bits used by the JAM error correction circuit 120 include both position error correction bits and magnitude error correction bits. If an error is detected, the position error correction bits are used to determine a position of the error within the data, and the magnitude error correction bits are used to determine how to change the data at the specified position. The JAM error correction circuit 120 includes a position encoding circuit 132 that generates the position error correction bits and a magnitude encoding circuit 134 that generates the encoding error correction bits. The JAM error correction circuit 120 uses a finite field to separate the data into symbols and then uses the finite field to determine how to generate the error correction bits and use them for error correction. The position and magnitude encoding circuit 132 and 134 may perform operations based on the logic within the finite field. This may allow for relatively simple logic, and relatively few logic gates, to be used to implement position and magnitude encoding circuits 132 and 134.

As part of an example write operation, the device 100 may receive a write command along with memory addresses which indicate where the write command should be performed. The IO circuit 122 receives data along the DQ terminals in synchronization with the DQS signal, and provides the data to the error correction circuit 120. The error correction circuit 120 generates error correction bits including position error correction bits and magnitude error correction bits. Responsive to internal commands (such as a row activate command ACT) issued by the command decoder 106, the word line selected by XADD is activated by the row decoder 108 and the data on the memory cells along that word line is amplified onto the intersecting bit lines by sense amplifiers (SAMP). Responsive to internal commands and the column address YADD, the column decoder 110 couples selected bit lines through local and global input/output lines (LIO and GIO) to the error correction circuit 120. The error correction circuit 120 provide the data and error correction bits along the LIO/GIO to the selected bit lines where it is written to the memory cells at the intersections with the active word line.

As part of an example read operation, the device 100 may receive a read command along with memory addresses which indicate where the read command should be performed. Responsive to internal commands (such as a row activate command ACT) issued by the command decoder 106, the word line selected by XADD is activated by the row decoder 108 and the data and error correction bits on the memory cells along that word line is amplified onto the intersecting bit lines by sense amplifiers (SAMP). Responsive to internal commands and the column address YADD, the column decoder 110 couples selected bit lines through local and global input/output lines (LIO and GIO) to the error correction circuit 120. The error correction circuit 120 determines if there is an error, and if so corrects the error. The error correction circuit 120 provide the corrected data to the IO circuit 122, which provides the data along one or more DQ terminals. The corrected data may be provided in synchronization with a data strobe clock DQS.

The device 100 may also receive commands causing it to carry out refresh operations. A refresh control circuit 116 may generate refresh address RXADD and the row decoder may refresh the word lines associated with that refresh address RXADD. The memory device 100 may receive a refresh signal REF and perform one or more refresh operations responsive to the refresh signal. In some embodiments, the refresh control circuit 116 may perform different types of refresh operations. For example, the refresh control circuit 116 may perform ‘normal’ refresh operations where the refresh address RXADD is generated using sequence logic, for example to count through the row addresses or the refresh control circuit 116 may perform targeted refresh operations on specific addresses (e.g., the victims of an identified aggressor).

The power supply terminals are supplied with power supply potentials VDD and VSS. The power supply potentials VDD and VSS are supplied to an internal voltage generator circuit 124. The internal voltage generator circuit 124 generates various internal potentials VPP, VARY, VPERI, and the like based on the power supply potentials VDD and VSS supplied to the power supply terminals. The internal potential VPP is mainly used in the row decoder 108, the internal potentials VARY are mainly used in the sense amplifiers SAMP included in the memory array 118, and the internal potential VPERI is used in many peripheral circuit blocks.

The power supply terminals are also supplied with power supply potentials VDDQ and VSSQ. The power supply potentials VDDQ and VSSQ are supplied to the input/output circuit 122. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

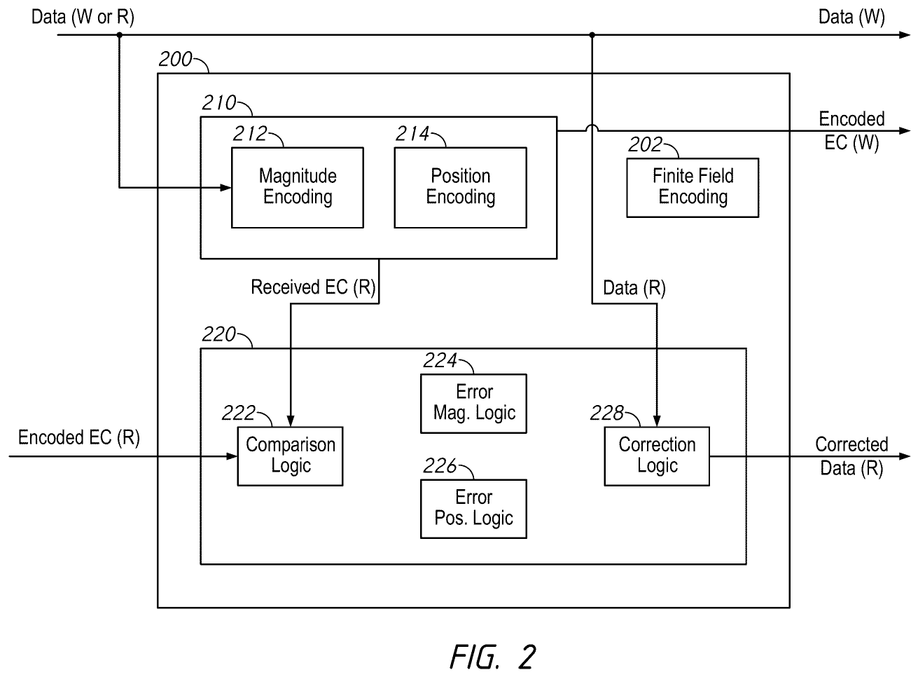

FIG. 2 is a block diagram of a JAM error correction circuit according to some embodiments of the present disclosure. The error correction circuit 200 may, in some embodiments, implement the error correction circuit 120 of FIG. 1.

The JAM error correction circuit 200 includes error correction bit generation logic circuits 210, error detection identification circuits 220 and finite field encoding logic circuits 202. The error correction bit generation logic circuits 210 are used to generate position and magnitude error correction bits during write or read operations. The error identification logic circuits 220 are used to determine if there is an error in read data, and if so to locate and correct the error. The finite field logic 202 is used to map the raw values of the data and error correction bits into the finite field.

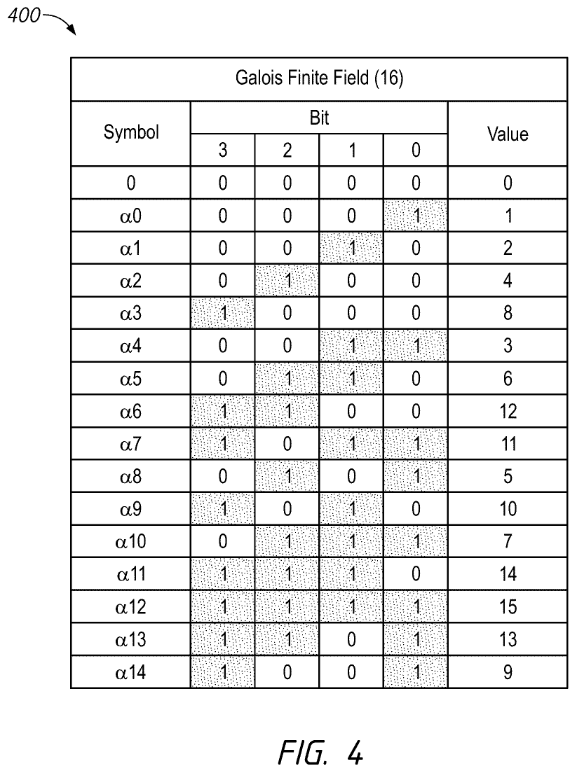

The JAM error correction circuit 200 uses a finite field, such as a Galois finite field, to split the data and error correction bits into one or more symbols. Each symbol is assigned a value a based on the value of the individual bits within that symbol. If the symbol is N bits long, there may be 2^{N}−1 different symbols values indexed as 0 and α⁰ to α^{(2\hat{ }N)-2}. The ‘0’ symbol value, which is different than α⁰, represents the symbol where all the individual bits are a logical low (e.g., 0). For example, if the symbol is 4 bits long, then there may be 15 symbol values from α⁰ to α¹⁴ and the 0 symbol. FIG. 4 shows an example of how symbol values may be assigned to a four bit symbol.

The JAM error correction circuit 200 includes a finite field encoding circuit which maps the values of bits into the corresponding symbols values. For example, in an example implementation where there are 128 data bits and the symbol length is 4 bits, then the data may be translated into 32 symbols. Similarly, if there are 4 error location bits and 4 error magnitude bits, then there may be one error location symbol and one error magnitude symbol. In some example embodiments, symbols of different lengths may be used for translating different pieces of information. For example, the error location bits may have a different symbol length than the error magnitude bits. In some embodiments, the information which uses symbols of shorter length may use a truncated version of the finite field. For example, if there are four bits for each symbol of the error location bits, but two bits for each symbol of the error magnitude bits, then the error magnitude bits may represent a subset of 3 symbol values of the 15 symbol values used for error location bits.

The error correction bit generation logic circuits 210 include a magnitude encoding circuit 212 and a position encoding circuit 214. The magnitude encoding circuit 212 generates the magnitude error correction bits by summing the symbol values of each codeword element of data according to Equation 1, below:

$${Encoded}_{MAG} = {\sum }_{0}^{{i}_{max}} {c}^{i} \qquad Eqn . l$$

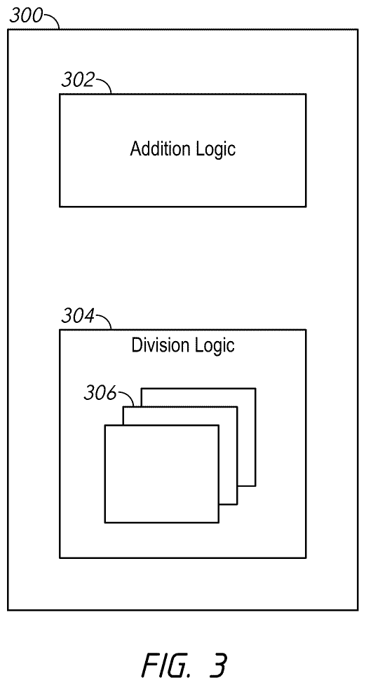

In Equation 1, c is the codeword element of the data for the magnitude, and i is an index of the number of codeword elements in the data based on the number of magnitude error correction bits. If there are M total bits in the data codeword, and N magnitude error correction bits, then the number of symbols in the codeword is iₘₐₓ=M/N. The sum of codeword elements in turn equals the sum of the symbol values of each codeword element a within the data codeword. The manner in which symbol values are summed in the finite field is discussed in more detail in FIG. 3.

The position encoding circuit 214 generates the position error correction bits by dividing each position codeword element d by a corresponding position symbol value pos according to Equation 2, below:

$${Encoded}_{POS} = {\sum }_{0}^{{i}_{max}} \frac{{c}^{i}}{{pos}^{i}} \qquad Eqn . 2$$

The position value pos assigns a position symbol value to each codeword element. For example, the first codeword element pos¹ may have a value of α¹, the second codeword element pos² may have a value of α² and so forth. In other words, c represents a value of the bits at that codeword location, and position indicates a value assigned to which position those bits are located in. The manner in which symbol values are divided in the finite field is discussed in more detail in FIG. 3. Which symbol value is associated to which position may be arbitrary. For example, the first codeword element does not have to match the first symbol value, however for ease of explanation herein, that convention will generally be used. Similarly, how the positions are determined may also be arbitrary. In some example embodiments, each position may represent a string of sequential bits within the data, however, other ways of defining the positions may also be used.

As described in more detail herein, the number of magnitude error correction bits determines the size of the symbol, and the number of bits of error which may be corrected by the error correction circuit 200. The error correction circuit 200 corrects up to all of the bits in a single magnitude symbol. For example, if there is a single magnitude error correction bit (e.g., N=1) then up to one bit of error may be corrected. If there are two magnitude error correction bits (e.g., N=2) then up to two bits of error may be corrected, as long as both those errors are within the same codeword element c.

The number of position error correction bits P determines how many positions within the data codeword have a defined location, and thus may be protected. For example, for P location error correction bits, there may be 2^{P}−1 total position symbol values (ignoring the 0 value) and thus 2^{P}−1 total locations may be protected. If 2^{P}−1 is greater than or equal to the total number codewords iₘₐₓ, then all locations may be corrected. If 2^{P}−1 is less than iₘₐₓ, then some magnitude symbols are uncorrectable. The number of position error correction bits P should be greater than or equal to the number of magnitude error correction bits N (e.g., P≥N) to prevent undefinable corrections. In some example embodiments, the same number of bits may be used for both magnitude and position encoding. In some example embodiments different numbers of bits may be used.

During an example write operation, the error correction circuit 200 receives data (e.g., from IO circuit 122 of FIG. 1). The data is translated into symbol values within the finite field by the finite field encoding circuit 202. The encoded data symbols are provided to the error correction bit generation logic circuits 210. The magnitude and position error correction bits are determined (from Equations 1 and 2 respectively), and the data, magnitude error correction bits and position error correction bits are all written to the array (e.g., 118 of FIG. 1). In other words, the total number of error correction bits EC=N+P, and the total amount of information written is M+EC.

During an example read operation, data and its associated error correction bits are received from the memory array. Similar to the write operation described above, the data and the error correction bits read from the array is encoded into finite field by the finite field encoding logic circuit 202. The error correction bit generation logic circuit 210 generates received error correction bits Encoded EC based on the data read from the memory array using Eqn 1 and Eqn 2. The error identification logic circuits 220 includes a comparison logic circuit 222 which compares the received EC to the encoded error correction bits read from the memory array. The comparison logic circuit 222 compares the encoded magnitude error bits to the received magnitude error bits and compares the encoded position error bits to the received position error bits. If there is not a difference, then it indicates the read bits do not contain an error and the read data is passed on to the IO circuit (e.g., 122 of FIG. 1). If there is a difference, then it indicates an error, and the error identification logic circuits 220 may correct the error.

The error identification logic circuits 220 include an error magnitude logic circuit 224 and an error position logic circuit 226. The error magnitude logic circuit 224 determines an error magnitude Error_{MAG} based on equation 3, below:

$${Error}_{MAG} = {Encoded}_{MAG} + {Received}_{MAG} \qquad Eqn . 3$$

The encoded magnitude Encoded_{MAG} are the magnitude error bits read from the array and the received magnitude Received_{MAG} are the magnitude error bits generated from the read data. The error position logic circuit 226 determines an error position based on equation 4, below:

$${Error}_{POS} = \frac{E r r o {r}_{MAG}}{{Encoded}_{POS} + {Received}_{P O S}} \qquad Eqn . 4$$

The error magnitude Error_{MAG} is generated by the error magnitude logic circuit 224, the encoded position error bits Encoded_{POS} are read from the array and the received position error bits Received_{POS} are generated from the read data by the position encoding circuit 214.

The error identification logic circuits 220 include correction logic circuits 228 which are used to correct the read data. The value of ErrorPOS is the value of the position where the error is located. The symbol at that position is corrected by adding the value of the error magnitude Error_{MAG} to the symbol at that location, as given by equation 5, below:

$${c}^{′i} {= {Error}_{POS}}^{} = {c}^{i = {Error}_{POS}} + {Error}_{MAG} \qquad Eqn . 5$$

The error correction c′ represents the change which is applied to the read data. The error correction c′ is used to overwrite the codeword element where the error was located in order to generate corrected data. The corrected data is then provided to the IO circuit.

In some embodiments, the JAM error correction circuit 200 may provide information about the detected errors in addition to, or instead of, correcting the data. For example, the JAM error correction circuit may track the number of bits of error which are changed by checking the number of bits of the error magnitude Error_{MAG} which are a logical high. This may be done by summing the individual bits of the Error_{MAG} using conventional addition logic (e.g., outside the finite field). In some embodiments, the number of corrected bits may be stored on the memory, reported to a controller, combined with other information, for example to track a total number of corrected bits, or combinations thereof.

FIG. 3 is a block diagram of logic circuits which may be used to implement one or more of the components of an error correction circuit according to some embodiments of the present disclosure. The logic circuits 300 may represent an example of the logic circuits which may be used to implement the operations of an error correction circuit such as the error correction circuit 120 of FIG. 1, 200 of FIG. 2, or combinations thereof. As may be seen from Eqns 1-5, the operations of the JAM error correction circuit may be implemented using addition within the finite field, or a combination of addition and division within the finite field.

For example, the magnitude encoding circuit (e.g., 212 of FIG. 2), error magnitude logic circuit (e.g., 224 of FIG. 2) and correction logic (e.g., 228 of FIG. 2) may operate using addition logic 302. The position encoding circuit (e.g., 214 of FIG. 2) and error position logic circuit (e.g., 226 of FIG. 2) may operate using both addition logic 302 and division logic 304. FIG. 3 describes addition logic circuits 302 and division logic circuits 304 in a generic sense based on how addition and division work within the finite field. The specific logic used for a given circuit may depend on the operation that circuit performs.

The addition logic circuit 302 adds two symbols together by performing a bitwise XOR of each element which makes up those symbols. Because of operations within the finite field, addition and subtraction may be identical operations. For that reason, only the term addition logic is used. However, the exact same bitwise XOR operation may be used for both addition and subtraction. Similarly, Equations 1-5 are expressed in terms of addition only, since subtraction is an equivalent operation. However, other example embodiments may use addition, subtraction, or a mix thereof for various operation expressed herein as addition only.

In a similar fashion, while the present disclosure is expressed in terms of division, multiplication within the finite field may be used instead (or in addition to the division). The operations expressed herein as division may be expressed instead as multiplication by the symbol with the negative exponent as the divisor mod the number of symbols. For example, if you were dividing α¹ by α³ you would get α^{(1-3)mod15} or α¹³. However that could also be expressed as α¹*a⁻³=α¹*α^{-3mod15}=α¹*α¹²=α¹³ Accordingly while terms like division are used herein and the equations are expressed in terms of division, it should be understood that the equations could be rearranged to allow for multiplication, division, or a combination thereof.

The division logic circuit 304 divides two symbols. Within the finite field, the division is performed by taking the difference between index of the two symbols and then taking the modulo of the number of symbols to give the index of the quotient symbol. An example division between two symbols is given by Equation 6, below:

$$\frac{{α}^{A}}{{α}^{B}} = {α}^{( A - B ) mod ( {2}^{N} - 1 )} \qquad Eqn . 6$$

Where A and B are the indices of the two symbols and N is the number of bits within that symbol. The division logic 304 may be implemented using combinational logic. For example, the division logic 304 may include a look up table 306. For example, since the position error bits Encoded_{POS} are generated based on a set number of denominators, all the different values of pos, those may index the look up table. Since there are a finite number of possible numerator values, those may act as inputs to the lookup table.

To aid understanding, an example implementation is described which uses a data codeword of 16 bits and 8 error correction bits, four magnitude error bits and four position error bits. Other amounts of data, magnitude error bits, position error bits, or combinations thereof may be used in other example embodiments.

FIG. 4 is a table showing an example finite field according to some example embodiments of the present disclosure. The finite field shown in the table 400 shows values for four bit symbols. The finite field of table 400 may be implemented in an error correction circuit such as 120 of FIG. 1, 200 of FIG. 2, or combinations thereof. For example the finite field of table 400 may be implemented by the finite field encoding logic 202 of FIG. 2.

Table 400 shows an example Galois Finite Field for all values of a four bit symbol. The first column shows the symbol value 0 and α⁰ to α¹⁴. The next four columns show the values of a set of bits, here labelled 3 to 0 from most to least significant, and the numerical value of that set of bits if it was expressed as a binary number. The finite field of table 400 is given by Equation 7, below:

$$F ( x ) = {x}^{4} + x + 1 \qquad Eqn . 7$$

The finite field shown in table 400 is just one example of a finite field which may be used for a four bit symbol. Other finite fields may be used in other example embodiments. For example, other equations different than Eqn. 7 may be used to generate the finite field elements. For consistency, the finite field of table 400 will generally be used in the examples herein.

Equations 8 and 9 below show an example of an addition and subtraction operation (which is the same as addition) within the finite field using the example finite field of table 400. Equations 10 and 11 below show an example of division operations within the finite field using the example finite field of table 400.

$$\begin{matrix} & \begin{matrix} & {α}^{4} & ( 0 & 0 & 1 & 1 ) \\ + & {α}^{5} & ( 0 & 1 & 1 & 0 ) \\ & {α}^{8} & ( 0 & 1 & 0 & 1 )\end{matrix}\end{matrix} \qquad Eqn . 8$$

$$\begin{matrix} & {α}^{11} & ( 1 & 1 & 1 & 0 ) \\ - & {α}^{1} & ( 0 & 0 & 1 & 0 ) \\ & {α}^{6} & ( 1 & 1 & 0 & 0 )\end{matrix} \qquad Eqn . 9$$

Equation 8 shows the addition of the symbols α⁴ and α⁵. Equation 9 shows the subtraction of α¹ from α¹¹. In each case, the equations show the symbols and the corresponding set of bits which match that symbol. Each bit of the result is given by a bitwise XOR of the corresponding bits of the input. For example, by taking the XOR of the most significant bits of the input symbols, you get the most significant bit of the result, and so forth. As may be seen by comparing the operations of Equations 8 and 9, addition and subtraction operate in an identical fashion. In this case, by adding the symbols α⁴ and α⁵ you get the symbol α⁸ and after subtracting α¹ from α¹¹, you get the symbol α⁶.

$$\frac{{α}^{10}}{{α}^{4}} = {α}^{( 10 - 4 ) mod 15} = {α}^{6 mod 15} = {α}^{6} \qquad Eqn . 10$$

$$\frac{{α}^{3}}{{α}^{7}} = {α}^{( 3 - 7 ) mod 15} = {α}^{- 4 mod 15} = {α}^{11} \qquad Eqn . 11$$

Dividing α⁴ from α¹⁰ gives the symbol α⁶ and dividing α⁷ from α³ gives the symbol α¹¹.

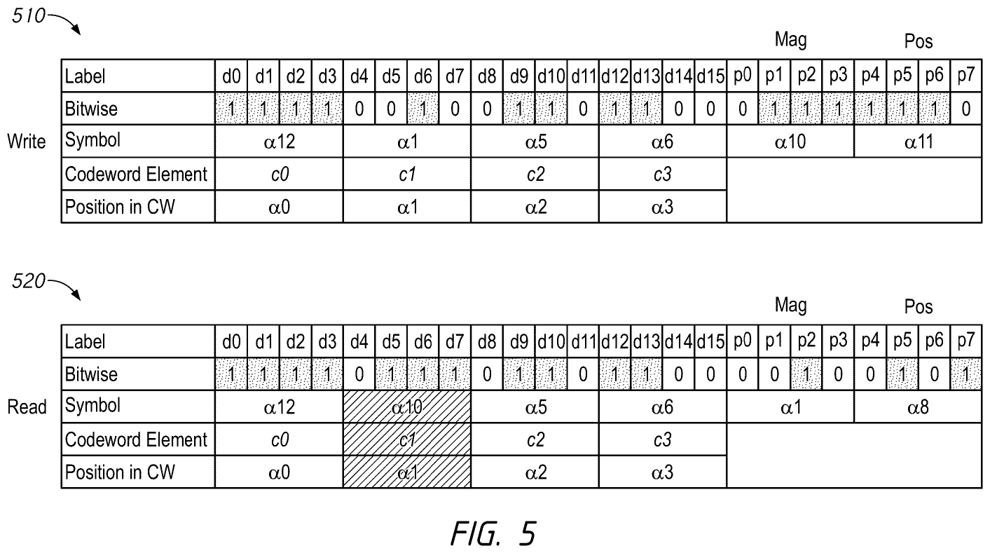

FIG. 5 are tables of an example set of data and error correction bits during write and read operations according to some examples of the present disclosure. Tables 510 and 520 of FIG. 5 shows an example set of data bits to show an example of how the data may be used to generate error correction bits and how those bits may be used to perform a correction. The example of FIG. 5 uses 16 data bits, or four symbols, and eight error correction bits, four of which are magnitude bits and four of which are position bits. Other numbers of bits may be used in other example embodiments.

The table 510 represents a set of data bits which are being written to the memory array as well as the error correction bits generated from the write data. The table 520 represents a state of that same set of bits when they are read from the array, with an error in one of the symbols, and the error correction bits generated from that read data.

The write data of table 510 includes a set of data bits d0 to d15. Because there are four bits per symbol, there are four codeword elements c0 to c3. The values of these symbols are converted into a finite field, in this case the finite field of table 400 of FIG. 4. The symbols of the write data are α¹², α¹, α⁵, and α⁶ respectively. The codeword positions are assigned the position values α⁰ to α³ respectively.

An error correction circuit (e.g., 120 of FIGS. 1 and/or 200 of FIG. 2) generates error correction bits from the data bits. The magnitude error correction bits p0 to p3 are generated using Eqn. 1 above. In this case, by taking the bitwise XOR of the four data symbols, the magnitude error correction bits end up being [0 1 1 1] which is the symbol α¹⁰. The error correction circuit also generates position error correction bits p4 to p7 using Eqn. 2 above. By dividing each symbol by its corresponding position element, that works out to the sum of α¹², α⁰, α³, and α³. That sum works out to the bits [1 1 1 0] which is the symbol α¹¹. In this manner, the error correction circuit generates the error correction bits [0 1 1 1 1 1 1 0], which is written to the array alongside the sixteen bits of data.

For the sake of this example, when the data is read, there is a two bit error in the data which is read out. Specifically, bits d5 and d7 have been changed (both from 0 to 1) in the read data of table 520. Because of this, the value of the symbol at codeword element c1, which contains both of those changed bits, has changed from α¹ to α¹⁰. The data is read out along with the original error correction bits α¹⁰ for the magnitude and α¹¹ for the position, now referred to as encoded error correction bits since they were encoded when the information was written to the memory array.

The error correction circuit generates a new set of error correction bits from the read data, using Eqns. 1 and 2 as described above. Since one of the symbols has changed, the received magnitude and position bits generated from the read data are also different. In this case the received magnitude is α¹ and the received position is α⁸. Since there is a mismatch between the received error correction bits and encoded error correction bits, the error correction circuit determines that there is an error and uses Eqns. 3 and 4 above to generate the error magnitude and error position.

The error magnitude is generated by summing the received magnitude error bits and the encoded magnitude error bits. By taking the bitwise XOR of the elements of those symbols, the error magnitude works out to α⁸. The error position is found by summing the denominator, which is the sum of the encoded position error bits and the received error position bits. In this example, that works out to α⁷. The numerator is the error magnitude, which is α⁸. That makes the error position work out to α¹. This indicates that the error is in the symbol which is in the codeword element assigned the value of α¹, which in this case is c1, and that the symbol α⁸ should be added to that symbol to correct it. In this case, the symbol at c1 is the one in error, and it was read out with a value of α¹⁰. The sum of α¹⁰ and α⁸ is α¹, which is the corrected symbol for that codeword element. Accordingly, the corrected data, with α¹ substituted in the c1 codeword element, restores the original sequence of bits used in the write data.

In an example implementation, it may be useful to match the number of data and error correction bits used in memory devices which use conventional error correction schemes. For example, a conventional memory device which uses Hamming codes for error correction may generally read and write data in codewords of 128 bits of data and use 8 error correction bits. The architecture of the memory array may reflect this arrangement. For example, the column decoder (e.g., 110 of FIG. 1) may access 8 bit lines in each of 17 column planes, 16 column planes for data and an error correction column plane for the parity bits. Accordingly, it may be useful to match that amount of data and error correction bits to avoid having the change the architecture of the memory.

In an example implementation, 128 data bits are used along with 8 error correction bits, 2 of which are used as magnitude error correction bits. This divides the 128 data bits into 64 code words of 2 bits each. The remaining 6 error correction bits are used as position error correction bits. The position error correction bits encode 2⁶−1=63 unique positions. This means that one of the two-bit codewords in the data will have a position which cannot be specified by the error correction bits, and thus cannot be corrected. This means that 126/128 or 98.4% of the data bits will be correctable. Since the symbol size is 2 bits, up to a two bit error in the data may be corrected as long as the error is within a single symbol and not in the unprotected symbol.

In another example implementation, if it is possible to use 9 error correction bits, then 128 data bits may be divided into three bit symbols by using 3 magnitude error correction bits and 6 position error correction bits. In this implementation, the data is split into 43 three bit symbols (one of which is a 2 bit symbol and a filler bit) and the position error correction bits can specify 63 positions. Accordingly, all of the data bits are protected with up to 3 bits correctable as long as the error is within a single symbol.

In another example implementation, using 128 data bits and 9 error correction bits, the data may be split into 32 four bit symbols by using four magnitude error correction bits. The remaining 5 position error correction bits encode 31 unique positions. This means that one of the four-bit codewords in the data will be unprotected since it cannot be specified. Accordingly 124/128 data bits or 97.1% of the data will be protected. Since the symbol size is 4 bits, up to a four bit error in the data may be corrected as long as the error is within a single symbol and not in the unprotected symbol.

An example implementation of the logic circuits 300 of FIG. 3 with respect to 128 data bits and 8 error correction bits is described. As discussed above, the 8 error correction bits are split into 2 magnitude error correction bits and 6 position error correction bits, which divides the data bits into 64 two bit symbols. For example, the magnitude encoding logic (e.g., 134 of FIGS. 1 and/or 212 of FIG. 2) may be implemented using the addition logic 302 of FIG. 3. The addition logic 302 performs a bit-wise XOR of each of the symbols (e.g., based on Eqn. 1, above). The bit wise XOR may be implemented based on a first step using 32 XOR logic circuits, a second step using 16 XOR gates, a third step using 8 XOR gates, a fourth step using 4 XOR gates, a fifth step using 2 XOR gates, and a sixth step using one XOR gate.

The position encoding logic (e.g., 132 of FIGS. 1 and/or 214 of FIG. 2) may be implemented using both the division logic 304 and the addition logic 302 of FIG. 3, for example using Eqn. 2. Because the data is divided into two bit symbols, there are only four possible numerator values (e.g., [00]=0, [01]=α⁰, [10]=α¹ and =α⁶). Because of this, the division logic 304 may be implemented using a look up table (e.g., 306 of FIG. 3) with 64 entries, one for each denominator, the position symbols assigned to the 63 correctable codeword elements, for example α¹ to α⁶². Since look up table entry has four possible inputs, it is possible to work out the logic for each possible input.

While not shown in detail herein, in this example implementation each look up table entry may be implemented by using at most one XOR gate. For example, in the case of the first position symbol α1=[000001] then if the input is 0, the output is [000000]=0. If the input is α⁰ then the output is [000001]=α62. If the input is α¹ then the output is [000001]=α⁰. If the input is α⁶, then the output is [100000]=α⁵. By comparing the bits of the inputs and the outputs, it can be seen that in this case, the look up table gives the value of the output as [c¹[0] 0 0 0 0 c¹[0]XORc¹[1]]. In other words the most significant bit of the output is a passthru of the least significant bit of the input, the least significant bit of the output is the XOR of the two bits of the input, and the remaining bits of the output are always zero. By repeating this exercise for each denominator, each look up table entry for this example implementation requires no more than one XOR gate per entry.

Accordingly, the position encoding logic for this example implementation includes 64 XOR gates in a worst case scenario (e.g., one XOR for each look up table entry of the division logic) and addition logic similar to the additional logic used for the magnitude error correction bits. In other words, a bit wise XOR may be implemented based on a first step using 32 XOR logic circuits, a second step using 16 XOR gates, a third step using 8 XOR gates, a fourth step using 4 XOR gates, a fifth step using 2 XOR gates, and a sixth step using one XOR gate.

Since each step introduces a single XOR gate worth of timing delay, and since the position and magnitude encoding logic may operate in parallel, the delay introduced when encoding the magnitude and position error correction bits is about 7 logic gates worth of delay, seven along the position encoding leg and six along the magnitude encoding leg. This may be comparable to the delay using Hamming encoding.

During a read operation, the error magnitude logic (e.g., 224 of FIG. 2) may have similar logic to the magnitude encoding such as addition logic which introduces about 6 gate's worth of delay to generate the encoded magnitude error correction bits. The error magnitude logic also includes an additional step of addition logic to generate the magnitude error (e.g., using Eqn. 3). This step adds an additional stage which includes two XOR gates to add the received magnitude error correction bits to the encoded bits.

The error position logic (e.g., 226 of FIG. 2) includes a mix of addition and division logic circuits in order to implement Eqn. 4. Since the position encoding and magnitude error must be determined first, the error position logic may add an additional 3-4 gate delays. Accordingly, this example implementation may add about 3-4 gate's worth of additional delay compared to Hamming codes.

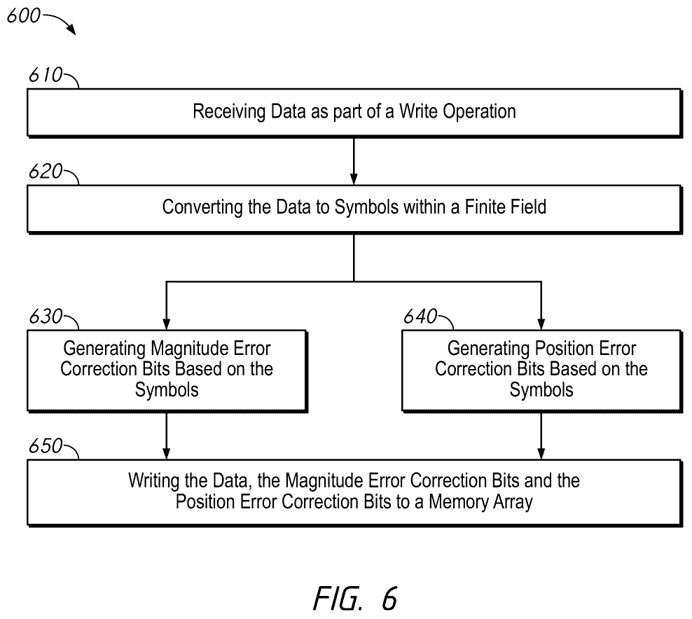

FIG. 6 is a flow chart of a method of performing a write operation using JAM error correction according to some example embodiments of the present disclosure. The method 600 may, in some embodiments, be implemented by one or more of the apparatuses, systems, or combinations thereof described herein. For example, the method 600 may be implemented by the memory device 100 of FIG. 1, the error correction circuit 200 of FIG. 2, or combinations thereof.

The method 600 may generally begin with box 610, which describes receiving data as part of a write operation. For example, the method 600 may include receiving data bits along DQ terminals with an IO circuit such as 122 of FIG. 1. In some example implementations, the method 600 may include receiving 128 bits of data. Other amounts of data may be used in other example implementations.

Box 610 is generally followed by box 620, which describes converting the data to symbols within a finite field. For example, box 620 may be performed by the finite field encoding logic 202 of FIG. 2. The converting may include splitting the data into different subsets based on a size of the symbols. For example, if the symbols have a length of 2 bits and there are 128 data bits, then box 620 may include splitting the data into 64 symbols of 2 bits each. The method 600 may include determining a value of each of the symbols based on the state of the bits within each symbol.

Box 620 is generally followed by boxes 630 and 640. In some embodiments, boxes 630 and 640 may be performed in parallel to each other. Box 630 describes generating magnitude error correction bits based on the symbols. For example, box 630 may be performed by magnitude encoding logic such as 134 of FIG. 1, 212 of FIG. 2, or combinations thereof. For example, box 630 may include performing Eqn. 1 to generate the magnitude error correction bits. Box 630 may include performing a bitwise XOR of the symbols, for example using addition logic such as 302 of FIG. 3.

Box 640 describes generating position error correction bits based on the symbols. For example, box 640 may be performed by position encoding logic such as 132 of FIG. 1, 214 of FIG. 2, or combinations thereof. For example, box 640 may include performing Eqn. 2 to generate the position error correction bits. Box 640 may include dividing the value of each symbol by a position value of each symbol, for example using division logic such as 304 of FIG. 3 to generate position quotients. In some embodiments, box 640 may include using a look up table (e.g., 306 of FIG. 3) to perform the dividing. Box 640 includes summing the quotients, for example by performing a bitwise XOR of the quotients (e.g., using addition logic such as 302 of FIG. 3).

Boxes 63 0 and 640 are followed by box 650, which describes writing the data, the magnitude error correction bits, and the position error correction bits to a memory array (e.g., 118 of FIG. 1). In an example implementation, the method 600 may include writing 128 data bits, 2 magnitude error correction bits and 6 position error correction bits to the memory array.

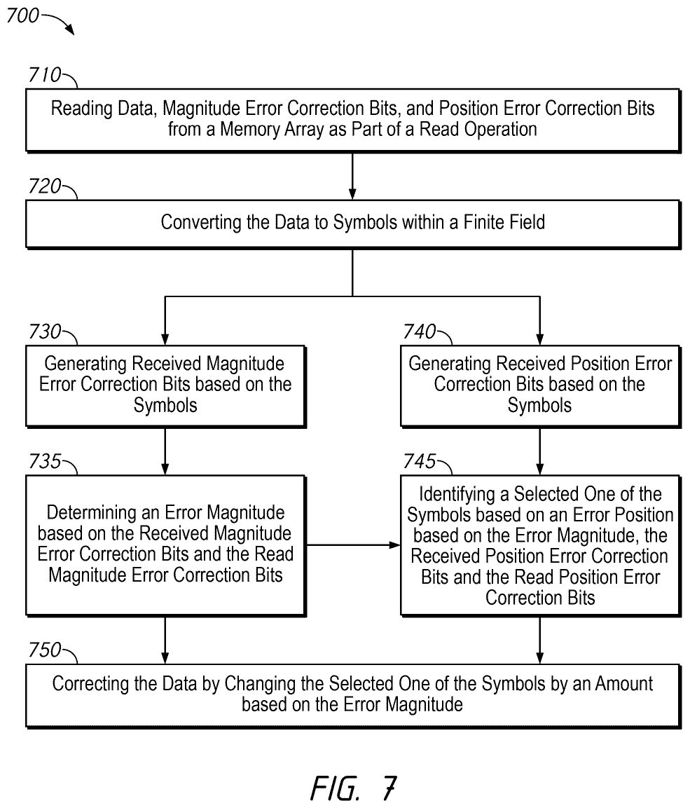

FIG. 7 is a flow chart of a method of performing a read operation using JAM error correction according to some example embodiments of the present disclosure. The method 700 may, in some embodiments, be implemented by one or more of the apparatuses, systems, or combinations thereof described herein. For example, the method 700 may be implemented by the memory device 100 of FIG. 1, the error correction circuit 200 of FIG. 2, or combinations thereof. The method 700 may involve reading data and error correction bits written using the method 600 of FIG. 6.

The method 700 may generally begin with box 710, which describes reading data, magnitude error correction bits, and position error correction bits from a memory array as part of a read operation. For example, the method 700 may include receiving a read command and reading the data and error correction bits from the memory array responsive to the read command.

Box 710 may generally be followed by box 720, which describes converting the data, to symbols within a finite field. Box 720 may generally be similar to box 620 of FIG. 6. For the sake of brevity, the operations already described with respect to box 620 will not be repeated for box 720. Box 720 may also include determining a respective symbol value for the magnitude error correction bits and position error correction bits based on the finite field. For example, the data may be split into a set of data bits, the magnitude error correction bits may represent a magnitude symbol and the position error correction bits may represent a position symbol.

Box 720 is generally followed by boxes 730 and 740. Boxes 730 and 740 may, in some embodiments, be performed in parallel to each other. Box 730 describes generating encoding magnitude correction bits based on the symbols. Box 740 describes generating encoding position error correction bits based on the symbols. Boxes 730 and 740 may generally be the similar to boxes 630 and 640 of FIG. 6, so for the sake of brevity details already described with respect to boxes 630 and 640 will not be repeated with respect to FIG. 7.

In some embodiments, after performing boxes 730 and 740, the method 700 may include comparing the encoded magnitude error correction bits to the read magnitude error correction bits and comparing the encoded position error correction bits to the read position error correction bits. For example, comparison logic circuits 222 of FIG. 2 may perform the comparing. If the encoded magnitude error correction bits match the read magnitude error correction bits and the encoded position error correction bits match the read position error correction bits, the method 700 may skip boxes 735-750 and instead proceed to providing the data to the DQ terminals. If there is at least one mismatch, the method 700 proceeds from boxes 730 and 740 to boxes 735 and 745 respectively.

Box 730 may generally be followed by box 735, which describes determining an error magnitude based on the encoded magnitude error corrections bits and the read magnitude error correction bits. For example, box 735 may be performed by error magnitude logic 224 of FIG. 2. For example, box 735 may include performing Eqn. 3 to generate the error magnitude. Box 735 may include performing summing the magnitude error correction bits and the encoded magnitude error correction bits. For example, box 735 may include performing a bitwise XOR of the symbols, for example using addition logic such as 302 of FIG. 3.

Boxes 735 and 740 may generally be followed by box 745, which describes identifying a selected one of the symbols based on an error position which is based on the error magnitude, the encoded position error correction bits, and the read position error correction its. For example box 745 may be performed by error position logic 226 of FIG. 2. Box 745 may include performing Eqn. 4 to generate the error position. Box 745 may include summing the encoded position error correction bits and read error correction bits (e.g., by performing a bitwise XOR with addition logic 302 of FIG. 3) and dividing the error magnitude by the sum (e.g., using the division logic 304 of FIG. 3).

Boxes 735 and 745 may generally be followed by box 750, which describes correcting the data by changing the selected one of the symbols by an amount based on the error magnitude. For example, box 750 may include performing Eqn. 5 to generate an error correction and applying the error correction to the data to generate corrected data. For example, the method 700 may include adding the error magnitude to the selected one of the symbols by performing a bitwise XOR (e.g., using addition logic such as 302 of FIG. 3) to correct the value of the selected one of the symbols. The method 700 may include providing the corrected data to DQ terminals of the memory device.

In some embodiments, the memory device may have a bounded fault specification. The bounded fault specification may be based on an external error correction operation. For example, the memory device (e.g., 100 of FIG. 1) may be coupled to a host or controller. The host or controller may have its own error correction circuit and its own error correction scheme. The host or controller may perform corrections at a different level than the memory device. For example, the host error correction scheme may be able to correct up to every bit in a single host error correction symbol, which may be larger than the symbols used by the error correction circuit of the memory. For example, the host error correction scheme may divide the data into symbols based on which DQ terminal the data is provided along. For example, if the data codeword is 128 bits, that may represent a burst of 32 serial bits along each of four DQ terminals. Each set of 32 bits may represent a host error correction symbol. The host error correction symbol may act as a fault region of the data.

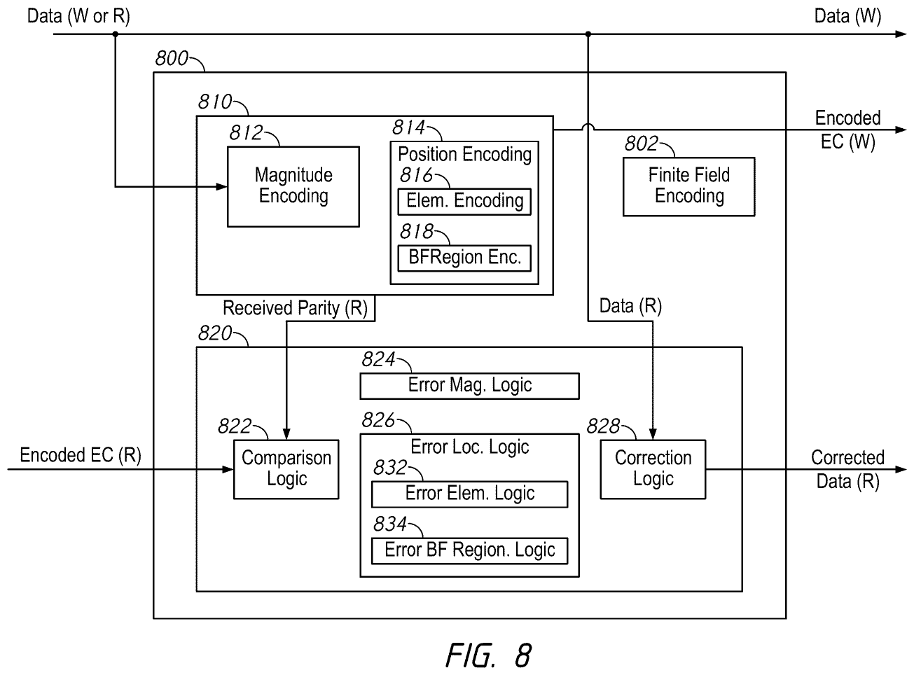

During on-device error correction, there may be situations where an uncorrectable error causes the error correction circuit to alias the data. For example, if there are errors in multiple symbols, the error correction circuit (e.g., 120 of FIG. 1) may incorrectly identify a data symbol and change it, further changing the data. In order to preserve the bounded fault specification it may be useful to perform JAM error correction in a manner which if the error is uncorrectable, but still within one fault region, the JAM error correction circuit aliases the data within the same fault region so that the controller may still be presented with data that is correctable. FIGS. 8-10 describe an example of a bounded fault compliant JAM error correction circuit and its operation according to some embodiments of the present disclosure.

FIG. 8 is a block diagram of a bounded-fault compliant JAM error correction circuit according to some embodiments of the present disclosure. The bounded fault JAM (BF-JAM) error correction circuit 800 may, in some embodiments, implement the error correction circuit 120 of FIG. 1. The BF-JAM error correction circuit 800 may be generally similar to the JAM error correction circuit 200 of FIG. 2, except that the BF-JAM error correction circuit 800 uses modified logic for the position encoding logic circuit 814, the error location logic circuit 826, and the correction logic circuit 828 compared to the analogous components of FIG. 2. For the sake of brevity, certain components and operations already described with respect to FIG. 2 will not be described again with respect to FIG. 8.

The BF-JAM error correction circuit 800 receives data as part of a write operation and uses error correction bit generation logic circuits 810 (e.g., 210 of FIG. 2) to generate error correction bits based on the data. The error correction bits include magnitude error correction bits generated by a magnitude encoding circuit 812 (e.g., 212 of FIG. 2) using Eqn. 1. The error correction bits also include position error correction bits which include both bounded fault region error correction bits and element position error correction bits. The position encoding circuit 814 includes an element encoding circuit 816 which generates the element position error correction bits and a bounded fault region encoding circuit 818 which generates the bounded fault region error correction bits.

The position encoding circuit 814 divides the data into bounded fault regions, and then into position elements within those fault regions. The bounded fault regions may be based on the bounded fault specification. For example, each bounded fault region may represent a controller error correction symbol, such as the data bits sent and received along a DQ terminal. The position element specifies a location of a symbol within the bound fault region. For example, a given symbol may be specified as being at the B^{th} position element in the A^{th} fault region. Each symbol cⁱ from c⁰ to c^{imax} can also be specified as c^{jk} where j is an index of fault regions and k is an index of position elements within the fault region.

The element encoding circuit 816 generates the element position error correction bits by summing the quotients of the sum of each symbol for a given position element value divided by an index elempos^{k} associated with that element's value according to equation 12, below:

$${Encoded}_{ELEMPOS} = {\sum }_{0}^{k max} \frac{{Σ}_{0}^{j max} {c}^{j k}}{{elempos}^{k}} \qquad Eqn . 12$$

Similarly, the fault region encoding circuit 818 generates the fault region error correction bits by summing the quotients of the sum of each symbol for a given region divided by an index BFposⁱ associated with that region according to equation 13, below:

$${Encoded}_{BFPOS} = {\sum }_{0}^{j max} \frac{{\sum }_{0}^{k max} {c}^{jk}}{{BFpos}^{j}} \qquad Eqn . 13$$

Similar to how each position was given a position symbol value in the position encoding circuit 214 of FIG. 2, the position encoding circuit 814 assigns a value to each element position and to each bounded fault position, from 0 to jmax and from 0 to kmax respectively. In some embodiments, the symbol values assigned to each index may overlap. For example, the symbol assigned to both j=1 and k=1 may be α¹. The manner in which values are assigned to the elements and regions may be arbitrary. During a write operation, the encoded element position error correction bits and the encoded region error correction bits are written to the array along with the data and the encoded magnitude error correction bits.

During a read operation, the BF-JAM error correction circuit 800 receives data, encoded magnitude error correction bits, encoded element position error correction bits and encoded region error correction bits from the array. The error correction bit generation logic circuits 810 generate received magnitude error correction bits, received element error correction bits, and received region error correction bits from the read data. The error identification logic circuit 820 (e.g., 220 of FIG. 2) includes comparison logic 822 (e.g., 222 of FIG. 2) which compares the encoded error correction bits to the received error correction bits. If there is not a difference, then there may not be an error and the read data is provided as-is. If there is a difference, then the error identification logic circuit 820 determines that there is an error and the error identification logic circuit 820 corrects the error.

The error magnitude logic circuit 824 (e.g., 224 of FIG. 2) generates an error magnitude Error_{MAG} by summing the encoded and received magnitude error correction bits according to Eqn. 3. The error location logic circuit 826 includes error element logic circuits 832 and error region logic circuits 834. The error element logic circuit 832 determines an error element Error_{ELEMPOS} based on equation 14, below:

$${Error}_{ELEMPOS} = \frac{E r r o {r}_{MAG}}{{{Encoded}_{ELEMPOS}}_{} + {Received}_{ELEMPOS}} \qquad Eqn . 14$$

The received element error correction bits Encoded_{ELEMPOS} are generated from the read data, and the encoded element error correction bits Received_{ELEMPOS} are read from the array. The error region logic circuit 834 determines an error region Error_{BFPOS} based on equation 15, below:

$${Error}_{BFPOS} = \frac{{Error}_{MAG}}{{Encoded}_{BFPOS} + {Received}_{BFPOS}} \qquad Eqn . 15$$

The received region error correction bits Encoded_{BFPOS} are generated from the read data, and the encoded region error correction bits Received_{BFPOS} are read from the array. The correction logic circuit 828 corrects the codeword element at element Error_{ELEMPOS} of the region Error_{BFPOS} based on equation 16, below:

$${c}^{′ i = {Error}_{ELEMPOS} , j = {Error}_{BFPOS}} = {c}^{i = i = {Error}_{ELEMPOS} , j = {Error}_{BFPOS}} + {Error}_{MAG} \qquad Eqn . 16$$

Similar to equation 5, above, equation 16 generates a corrected codeword element which is inserted into the data in place of the codeword element where the error was located to generate corrected data. The corrected data is provided to the IO circuit.

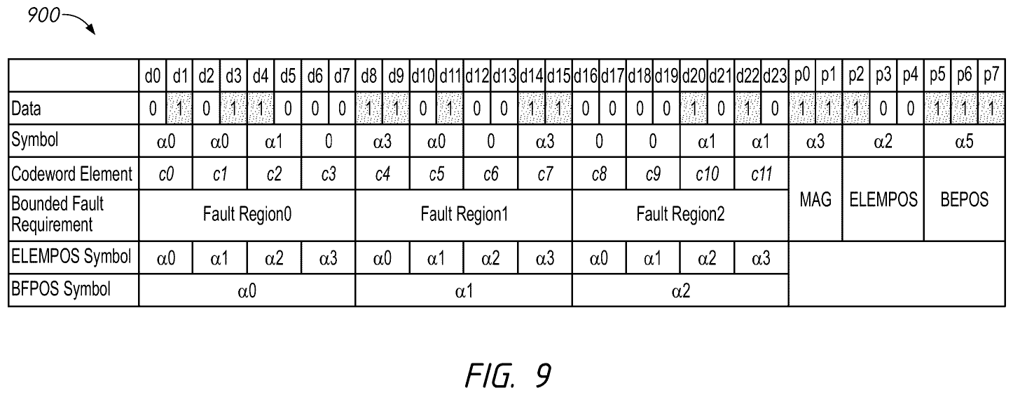

FIG. 9 is a table of an example set of data and error correction bits according to some examples of the present disclosure. Similar to the tables 510 and 520 of FIG. 5, table 900 of FIG. 9 shows an example set data bits and the error correction bits which may be generated therefrom. The example of FIG. 9 uses 24 data bits d0 to d24, which are divided into symbols of two bits each c0 to c11. The symbols are organized into three fault each of which includes four element positions. Eight error correction bits are used, two magnitude error correction bits, three element error correction bits, and three region error correction bits. Other numbers of data and error correction bits, other arrangements of elements and regions, or both may be used in other example embodiments. The example of FIG. 9 uses a different finite field than the example finite field of FIGS. 4-5.

The three bounded fault regions are assigned values of α⁰, α¹, and α². The elements within each region are assigned the values of α⁰, α¹, α², and α³. By plugging the arrangement of regions and elements of table 900 into Eqns. 13 and 14 above, we get Equations 16 and 17, below:

$${Encoded}_{ELEMPOS} = \frac{{c}^{0} + {c}^{4} + {c}^{8}}{{α}^{0}} + \frac{{c}^{1} + {c}^{5} + {c}^{9}}{{α}^{1}} + \frac{{c}^{2} + {c}^{6} + {c}^{10}}{{α}^{2}} + \frac{{c}^{3} + {c}^{7} + {c}^{11}}{{α}^{3}} \qquad Eqn . 17$$

$${Encoded}_{BFPOS} = \frac{{c}^{0} + {c}^{1} + {c}^{2} + {c}^{3}}{{α}^{0}} + \frac{{c}^{4} + {c}^{5} + {c}^{6} + {c}^{7}}{{α}^{1}} + \frac{{c}^{8} + {c}^{9} + {c}^{10} + {c}^{11}}{{α}^{2}} \qquad Eqn . 18$$

If the individual values for the symbols are plugged in to Eqn. 17, then the element error correction bits work out to α²=[100] and if the values are plugged into Eqn. 18, then the region error correction bits work out to α⁵=[111].

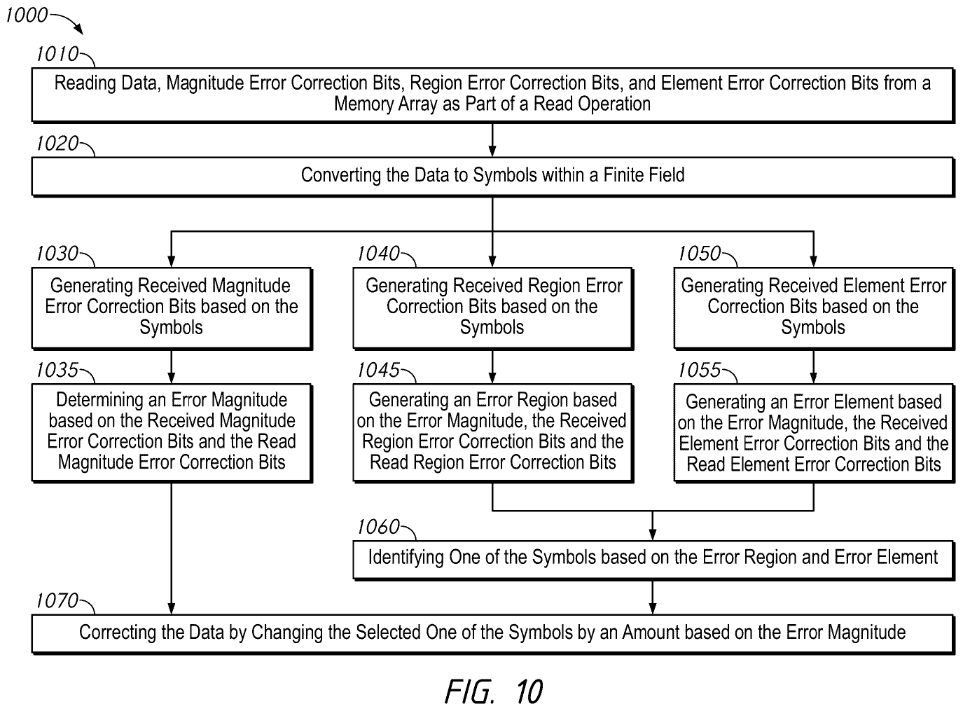

A BF-JAM circuit may operate in a manner similar to the methods described in FIGS. 6 and 7, except that the BF-JAM generates additional information (e.g., region and element error bits) as part of the position error correction bits and uses that information generate an error region and an error element. For example, the method 600 of FIG. 6 may include generating region error correction bits by summing each element in the region and dividing by a region position value to get a region quotient and then summing the region quotients (e.g., based on Eqn. 13 above). The method 600 may also include generating element error correction bits by summing each symbol of a given element for each region and dividing by an element value to get an element quotient, and then summing the element questions (e.g., based on Eqn. 12, above). The region and element error correction bits are written to the memory array as the position error correction bits. FIG. 10 describes an example modification of the method 700 of FIG. 7 using BF-JAM error correction.

FIG. 10 is a flow chart of a method of performing a read operation using BF-JAM error correction according to some example embodiments of the present disclosure. The method 1000 may, in some embodiments, be implemented by one or more of the apparatuses, systems, or combinations thereof described herein. For example, the method 1000 may be implemented by the memory device 100 of FIG. 1, the error correction circuit 800 of FIG. 8, or combinations thereof. The method 1000 may involve reading data and error correction bits written using the method 600 of FIG. 6 as modified to include region and element error correction bits. The method 1000 may be a modification of the method 700 of FIG. 7. For the sake of brevity, certain details and operations already described with respect to FIG. 7 are not repeated again with respect to FIG. 10.

The method 1000 may generally begin with box 1010, which describes reading data, magnitude error correction bits, region error correction bits, and element error correction bits from a memory array as part of a read operation. Box 1010 may generally be followed by box 1020, which describes converting the data into symbols within a finite field. Box 1020 may happen in a manner generally analogous to box 720 of FIG. 7, except that in box 1020, each symbol is specified by both a region and an element within that region.

Box 1020 may generally be followed by boxes 1030 and 1035 which describe generating encoded magnitude error correction bits based on the symbols and determining an error magnitude based on the encoded magnitude error correction bits and the read magnitude error correction bits. Boxes 1030 and 1035 may be generally analogous to boxes 730 and 735 of FIG. 7. Box 1020 is also followed by box 1040 which describes generating encoded region error correction bits based on the symbols. For example, box 1040 may include performing Eqn. 13 using addition and division logic (e.g., 304 and 302 of FIG. 3). Box 1020 is also followed by box 1050 which describes generating encoded element error correction bits based on the symbols. For example, box 1050 may include performing Eqn. 12 using addition and division logic (e.g., 304 and 302 of FIG. 3).

Box 1040 may generally be followed by box 1045 which describes generating an error region based on the error magnitude, the encoded region error correction bits and the read region error correction bits. For example, box 1045 may include performing Eqn. 15. Box 1050 may generally be followed by box 1055 which describes generating an error element based on the error magnitude, the encoded element error correction bits and the read element error correction bits. For example, box 1055 may include performing Eqn. 14. Boxes 1045 and 1055 are followed by box 1060, which describes identifying one of the symbols based on the error region and error element. For example, the error region may correspond to a value of one of the regions and the error element may correspond to an element position. The identified symbol is the one that matches the region and element.

Boxes 1035 and 1060 may generally be followed by box 1070, which describes correcting the data by changing the selected one of the symbols by an amount based on the error magnitude. Box 1070 may generally be similar to 750 of FIG. 7, except that Eqn. 16 is used.

It is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
an error correction circuit configured to receive data as part of a write operation, the error correction circuit comprising:
finite field logic configured to split the data into symbols within a finite field;
a magnitude encoding circuit configured to generate magnitude error correction bits based on the symbols;
a position encoding logic circuit configured to generate position error correction bits based on the symbols; and
a memory array, wherein the data, the magnitude error correction bits, and the position error correction bits are written to the memory array as part of the write operation.

2. The apparatus of claim 1, wherein the error correction circuit is further configured to receive read data, read magnitude error correction bits and read position error correction bits as part of a read operation and to generate received magnitude error correction bits and encoded position error correction bits,
wherein the error correction circuit further comprises error identification logic configured to determine an error magnitude based on the read magnitude error correction bits and the encoded magnitude error correction bits and to determine an error position based on the error magnitude, the read position error correction bits and the received position error bits, and to correct the read data based on the error magnitude and the error position.

3. The apparatus of claim 2, wherein the error identification logic is configured to correct up to all of the bits in one of the symbols in the read data.

4. The apparatus of claim 1, wherein the magnitude encoding circuit is configured to sum a value of the symbols using addition logic within the finite field, wherein the addition logic includes a plurality of XOR gates configured to perform a bitwise XOR of the symbols.

5. The apparatus of claim 1, wherein the position encoding logic circuit includes division logic within the finite field configured to divide each symbol by a position value of the symbol to determine a quotient and addition logic configured to sum the quotients by performing a bitwise XOR of the symbols.

6. The apparatus of claim 4, wherein the division logic includes a look up table indexed by the position value.

7. The apparatus of claim 1, wherein the data is divided into at least two fault regions, and wherein the position error correction bits include region error correction bits and element error correction bits, wherein the region error correction bits specify one of the at least two fault regions and the element error correction bits specify a symbol position within the region.

8. The apparatus of claim 7, wherein the error correction circuit is further configured to receive, read data, read magnitude error correction bits and read position error correction bits as part of a read operation and correct an error in the read data based on the read data, the read magnitude error correction bits and the read position error correction bits, and wherein if there is an uncorrectable error in one of the at least two fault regions, the error correction circuit is configured to not alias into another of the at least two fault regions.

9. A method comprising:
receiving data;
converting the data to symbols within a finite field;
generating magnitude error correction bits based on the symbols; and
generating position error correction bits based on the symbols.

10. The method of claim 9, further comprising:
receiving the data as part of a write operation; and
writing the data, magnitude error correction bits and position error correction bits to a memory array.

11. The method of claim 9, further comprising:
receiving the data, read magnitude error correction bits, and read position error correction bits from a memory array as part of a read operation;
determining an error magnitude based on the magnitude error correction bits and the read magnitude error correction bits;
identifying a selected one of the symbols based on an error position based on the error magnitude, the position error correction bits and the read error correction bits; and
correcting the data by changing the selected one of the symbols by an amount based on the error magnitude.

12. The method of claim 11, further comprising correcting up to all of the bits within the selected one of the symbols.

13. The method of claim 9, further comprising generating the magnitude error correction bits by summing the symbols within the finite field.

14. The method of claim 9, further comprising generating the position error correction bits by dividing each of the symbols by a position value within the finite field to generate a quotient and summing the quotients within the finite field.

15. The method of claim 9, wherein generating the position error correction bits includes generating region error correction bits and element error correction bits.

16. An apparatus comprising:
a memory array configured to provide data, magnitude error correction bits and position error correction bits as part of a read operation; and
a Jenkinson adjusted magnitude (JAM) error correction circuit configured to convert the read data into symbols, determine an error magnitude based in part on the read magnitude error correction bits, determine an error position based in part on the error magnitude and the read position error correction bits, and correct the data by adjusting a symbol identified by the error position by an amount determined by the error magnitude.

17. The apparatus of claim 16, wherein the JAM error correction circuit includes:
a magnitude encoding circuit configured to generate received magnitude error correction bits by summing the symbols within a finite field; and
an error magnitude logic circuit configured to generate the error magnitude by summing the read magnitude error correction bits and the magnitude error correction bits within the finite field.

18. The apparatus of claim 17, wherein the magnitude encoding circuit includes a plurality of XOR gates configured to sum the symbols within the finite field by performing a bitwise XOR of the symbols.

19. The apparatus of claim 16, wherein the JAM error correction circuit includes:
a position encoding circuit configured to generate encoded position error correction bits by dividing each of the symbols by a symbol position to generate quotients within a finite field and summing the quotients within the finite field; and
an error position logic circuit configured to generate the error position by dividing the error magnitude by a sum of the position error correction bits and the encoded position error correction bits within the finite field.

20. The apparatus of claim 19, wherein the position encoding circuit includes a look-up table configured to generate the quotients, wherein the look up table includes a plurality of entries indexed by the symbol position, and wherein each of the plurality of entries includes no more than one XOR logic gate.
